(19) United States
(12) Patent Application Publication
(10) Pub. No.: US 2013/0322948 A1
(43) Pub. Date: Dec. 5, 2013

(54) WRITING UTENSIL HOLDING SYSTEM

(71) Applicant: GIANNA F. MADDOX, Capitol Heights, MD (US)

(72) Inventor: GIANNA F. MADDOX, Capitol Heights, MD (US)

(21) Appl. No.: 13/488,912

(22) Filed: Jun. 5, 2012

(51) Int. Cl. B43K 23/00; B23P 11/00

(52) U.S. Cl. 401/8; 29/525.01

(57) ABSTRACT

A writing utensil holding system that includes a band, where the band is capable of being place around a user's hand; and a writing utensil holder attached to the band, where the holder is capable of receiving a writing utensil. The utensil holder may be configured in a loop-type fashion. In one exemplary embodiment, the band and holder may be made of elastic material.

### BACKGROUND OF THE INVENTION

1. Field of Invention

The present invention relates to a writing utensil holding system to secure a writing utensil during use.

2. Description of Related Art

Many individuals use writing utensils for notes, drawings or for other purposes, such as students taking notes in class, draftsmen working on documents or other professionals who utilize writing utensils on a daily basis such as carpenters or engineers. Some individuals such as artists use multiple writing utensils or may have to change writing utensils while they are working on their particular document or piece of work. Normally an individual may have a particular location to place writing utensils such as a holder or perhaps a drawer, however, many individuals place writing utensils down and then have to locate the utensil at a later time after leaving their desk or walking away from that particular location.

Consequently it would be advantageous to have a device that could be conveniently attached to a user's body that conveniently secures a writing utensil doing use. The writing utensil could be secured during non-use and therefore easily located when the user desires to engage in the use of the writing utensil.

### SUMMARY OF THE INVENTION

The present invention relates to a writing utensil holding system comprising: a band, where the band is capable of being place around a user's hand; and a writing utensil holder attached to the band, where the holder is capable of receiving a writing utensil. The utensil holder may be configured in a loop-type fashion. In one exemplary embodiment, the band and holder may be made of elastic material.

### BRIEF DESCRIPTION OF DRAWINGS

FIG. 1A depicts use of a writing utensil holding system in accordance with the present invention where a band is stretched across the palm and hand of a user.

FIG. 1B depicts use of a writing utensil holding system in accordance with the present invention where the band is stretched across the wrist of a user.

FIG. 2 depicts use of the writing utensil holding system during use by a user.

### DETAILED DESCRIPTION

The present invention relates to a writing utensil holding system that may be placed on a user's hand to secure a writing utensil within easy reach and convenience for the user. The writing utensil holding system includes a band that extends around the circumference of the hand and a utensil holder placed upon the band that secures the writing utensil for the user. The band and the holder may be positioned to hold the writing utensil both during use of the utensil and also when the utensil is not being used by the user.

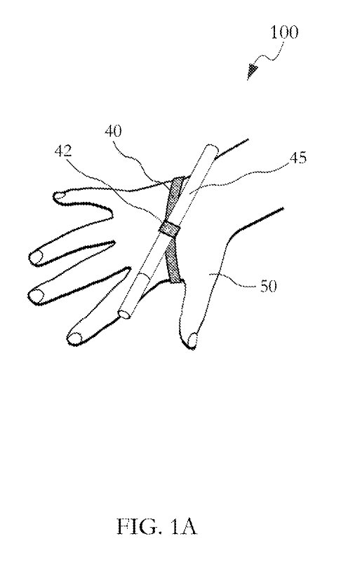

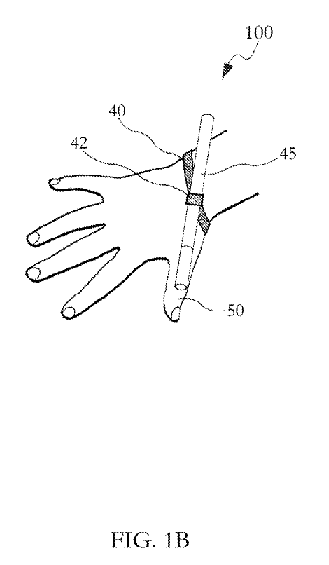

In reference to FIG. 1A, a perspective view of a writing utensil holding system 100 is in accordance with the present invention is depicted. The writing utensil holding system 100 includes a band 40 that includes a writing utensil holder 42. As shown, the band 40 extends across the perimeter of a user's hand 50 and the writing utensil 45 is placed within the holder 42. This configuration allows a user to place the band 40 and holder 42 around their hand in order to secure the writing utensil 45 within the holder 42. In the preferred embodiment of the present invention, the holder 42 is placed on the backside of the hand 50 as opposed to the palm area. FIG. 1B depicts an alternative placement of the band 40, where the band 40 is maintained around the wrist of the user. Either arrangement allows an individual or user to use their hand while the band and holder are placed around the perimeter of their hand. The holder 42 may be configured in a loop type fashion in order to receive a writing utensil.

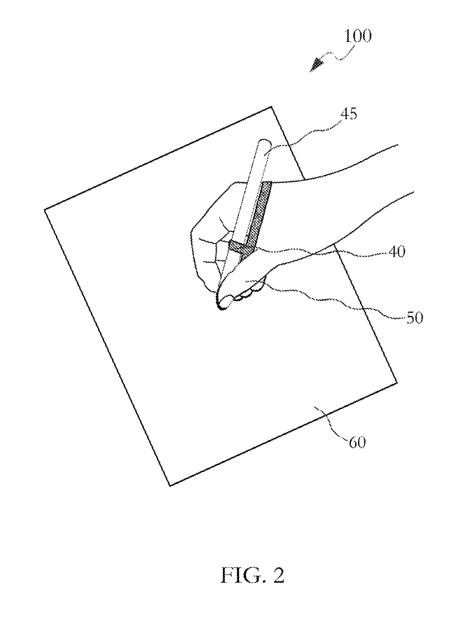

In reference to FIG. 2, a depiction of the utensil holding system 100 is shown during use. Here a user has placed the band 40 around their hand 50, which secures the writing utensil 45. The band 40 therefore allows the user to both use the writing utensil 45 and then secure it during non-use as depicted in FIG. 1. Overall the present invention provides an efficient and a suitable device to secure a writing utensil for a user. The band 40 may be made of various elastic materials so that it may fit various sizes of hands. Further the utensil holder 42 may also be made of elastic material to allow for convenient use with various types of writing utensils. Although not shown, the band 40 may be decorated and stylized with text. In one exemplary embodiment, a company or school name or logo may be embroidered into the band 40. The instant invention has been shown and described in what it considers to be the most practical and preferred embodiments. It is recognized, however, that departures may be made there from within the scope of the invention and that obvious modifications will occur to a person skilled in the art.

1. A writing utensil holding system comprising:
a. a band, where the band is adapted to extend across a perimeter of an anterior, palm, and posterior, backside, of a user's hand and said band is adapted to move downward over a wrist of the user; and
b. a writing utensil holder attached to the band, where the holder is capable of receiving a writing utensil and the holder is placed on a backside of the user's hand.

2. The writing utensil according to claim 1, where the utensil holder is a loop.

3. The writing utensil according to claim 1, where the band is made of elastic material.

4. The writing utensil according to claim 1, where the holder is made of elastic material.

5. A method of securing a writing utensil in a secure position comprising the steps of:
a. placing a band around a perimeter of an anterior, palm, and posterior, backside, of a user's hand, where the band includes a writing utensil holder; and
b. positioning the holder on a backside of the user's hand; and
c. inserting a writing utensil into the writing utensil holder.

6. A method of securing a writing utensil in a secure position comprising the steps of:
a. placing a band around a perimeter of a user's wrist, where the band includes a writing utensil holder; and
b. positioning the holder on a backside of the user's wrist; and
c. inserting a writing utensil into the writing utensil holder.
